(19) United States
(12) Patent Application Publication
(10) Pub. No.: US 2005/0181947 A1
(43) Pub. Date: Aug. 18, 2005

(54) Fungicidal seed treatment agent for oilseed rape

(75) Inventors: Thomas Puhl, Bergheim (DE); Dirk Bruggemann, Wulfsen (DE)

Correspondence Address: BIRCH STEWART KOLASCH & BIRCH, PO BOX 747, FALLS CHURCH, VA, 22040-0747, US

(73) Assignee: BASF Agro BV., Amhem (NL)-Wadenswil-Branch, Switzerland (CH)

(21) Appl. No.: 10/515,053

(22) PCT Filed: May 21, 2003
(86) PCT No.: PCT/EP03/06210

(30) Foreign Application Priority Data
May 29, 2002 (DE) 102 24 348.4

(51) Int. Cl. A01N 25/26

(52) U.S. Cl. 504/100

(57) ABSTRACT

The fungicidal active substance fluquinconazole is suitable for the seed treatment of oilseed rape (Brassica napus).

The present invention relates to the use of the active substance fluquinconazole as a seed treatment agent.

Fluquinconazole (BSI ‘common name’), IUPAC name: 3-(2,4-dichlorophenyl)-6-fluoro- 2-(1H-1,2,4-triazol-1-yl)-quinazolin-4(3H)-one, Chemical Abstract Name: 3-(2,4- dichlorophenyl)-6-fluoro-2-((1 H)-1,2,4-triazol-1-yl)-4(3H)-quinazolinone, CAS-RN: [136426-54-5], is known as a fungal active substance used to control a broad spectrum of fungi from the groups Ascomycetes, Deuteromycetes and Basidiomycetes by foliar application to broad-leaved cultivated plants and cereal plants, such as, for example, Venturia inaequalis and Podosphaera leucotricha in apples, Uncinula necator in vines, Puccinia spp. and Septoria spp. in wheat, Cercospora, Erysiphe and others in sugar beet, as well as other economically important fungal diseases in oilseed rape, stone fruit and other cultures. In addition to foliar application, a controlling effect on some fungal diseases of cereals was also demonstrated by seed treatment with this active substance in wheat and barley, substantially on the soil-borne specific fungicidal pathogens of Take-all in cereals, such as for example, Gaeumannomyces graminis var tritici (The 1998 Brighton Conference—Pests and Diseases, Section 9A-3, pages 907-912 and Section 4D-2, pages 301-302).

The object of the present invention was to discover further areas of application for the active substance fluquinconazole.

It is to be regarded as surprising that by using fluquinconazole for the treatment of oilseed rape seed, it has been possible to promote the early development of oilseed rape plants and that, in addition, even long-term protection against phytopathogenic fungi which appear especially on the leaves of oilseed rape was achieved.

The object of the present invention is thus the use of fluquinconazole for the seed treatment of oilseed rape.

The invention not only makes it possible to combat fungal diseases in oilseed rape economically and ecologically advantageously, but also leads to an improvement in plant health and vitality.

Fluquinconazole is generally used according to the invention in concentrations of 0.001 to 50 g of active substance per kilogram of seed, preferably 0.01 to 10 g, especially preferably 0.1 to 5 g.

Fluquinconazole can be used in this case either directly or as a ready-formulated product. The concentration of fluquinconazole in the formulated product is generally 0.1 to 90 wt. % of active substance, preferably 1 to 60 wt. %, especially preferably 5 to 30 wt. %.

In addition, fluquinconazole as active substance or ready-formulated product can also be used together with further suitable additives for the treatment of seed (synonymous with dressing the seed).

A further object of the present invention is the use of fluquinconazole for the seed treatment of oilseed rape, whereby fluquinconazole is combined with suitable additives.

All the usual components which can be used in a mixture with fluquinconazole can be considered as additives, such as, for example, dyes, wetting agents, dispersing agents, emulsifiers, defoaming agents, preservatives, drying-delaying components, antifreeze agents, secondary thickening substances, solvents, adhesives and biologically degradable polymers.

All the usual dyes for such purposes can be considered as dyes which can be combined with fluquinconazole. Both pigments barely soluble in water and water-soluble dyes can be used. As examples, mention may be made of the dyes known by the names Rhodamin B, C.I. Pigment Red 112 and C.I. Solvent Red 1.

All wetting-promoting substances normally used to formulate agrochemical active substances can be considered as wetting agents which can be combined with fluquinconazole. Preferably used are alkylnaphthalene sulfonates such as diisopropyl or diisobutyl naphthalene sulfonates.

All the usual nonionic, anionic and cationic dispersing agents for formulating agrochemical active substances can be considered as dispersing agents and/or emulsifiers which can be combined with fluquinconazole. Preferably used are nonionic or anionic dispersing agents or mixtures of nonionic or anionic dispersing agents. As suitable nonionic dispersing agents, mention may be made in particular of ethylene oxide-propylene oxide block polymers, alkyl-phenol polyglycol ether and tristyrylphenol polyglycol ether and their phosphated or sulfated derivatives. Suitable anionic dispersing agents are especially lignin sulfonate, polyacrylic acid salts and aryl sulfonate formaldehyde condensates.

All foam-inhibiting substances usually used to formulate agrochemical active substances can be contained as defoaming agents in combination with fluquinconazole. Preferably used are silicone de-foaming agents and magnesium stearate.

All substances which can be used for such purposes in agrochemical agents can be present as preservatives in combination with fluquinconazole. As examples, mention may be made of dichlorophene and benzyl alcohol hemiformal.

All substances which can be used for such purposes in agrochemical agents can be considered as drying-delaying components and as antifreeze agents which can be combined with fluquinconazole. Preferably considered are polyvalent alcohols such as glycerol, ethanediol, propanediol, and polyethylene glycols of various molecular weights.

All substances which can be used for such purposes in agrochemical agents can be considered as secondary thickening agents which can be combined with fluquinconazole. Preferably considered are cellulose derivatives, xanthan, modified clays and highly disperse silica

All organic solvents which can be used in agrochemical agents can be considered as solvents which can be combined with fluquinconazole. Preferably considered are ketones such as methyl isobutyl ketone and cyclohexanone, furthermore amides such as dimethylformamide, furthermore cyclic compounds such as N-methylpyrrolidone, N-octylpyrrolidone, N-dodecyl pyrrolidone, N-octylcaprolactam,

N-dodecyl caprolactam and (y-butyrolactone, additionally, strongly polar solvents such as dimethylsulfoxide, furthermore aromatic hydrocarbons such as xylol, in addition esters such as propylene glycol monomethylether acetate, dibutyl adipate, hexyl acetate, heptyl acetate, tri-n-butyl citrate, diethyl phthalalte and di-n-butyl phthalate, and furthermore alcohols such as ethanol, n- and i-propanol, n- and i-butanol, n- and i-amyl alcohol, benzyl alcohol and 1-methoxy-2-propanol.

All binders usually used in seed treatment agents can be considered as adhesives which can be combined with fluquinconazole. Preferably mentioned are polyvinyl pyrrolidone, polyvinyl acetate, polyvinyl alcohol and tylose.

The usual biologically degradable, natural and synthetic substances are considered as polymer admixture components. Preferably considered are polyester, polyether ester, copolyester, polyanhydride, polyester urethane, thermoplastic polysaccharide or polysaccharide derivatives and also polyester, polyether ester and polyester amide which contain aliphatic and aromatic ester groupings.

Especially preferred admixture components are polyesters such as polyactide, polyglycolide, polycaprolactone, polyhydroxyalkanolate, polyasparaginic acid and polytartrate, further thermoplastic polysaccharides, such as cellulose ester, cellulose ether, cellulose ether ester and starch derivatives, such as starch ester, and also thermoplastic starch.

The concentrations of the individual components in the fluquinconazole formulations used according to the invention can be varied within a fairly large range. Thus, the content of individual additives is generally between 0.0001 and 99.9999 wt. %, preferably between 0.001 and 99.999 wt. %.

The additives can either be combined individually directly or as a preliminary mixture of a plurality of additives with fluquinconazole.

All possible types of formulations can be considered, according to how it is predetermined by the biological and/or chemicophysical parameters, for example: dressing, water- or oil-based dispersions (FS or SC), spray powders (WP), emulsifiable concentrates (EC), aqueous solutions (SL), suspoemulsions (SE), dusting powders (DP), granules in the form of micro-, spray, coating and absorption granules, water-dispersible granules (WG), emulsions, sprayable solutions, microcapsules, waxes, foams, pastes and gels, preferably special formulations for seed treatment (synonymous with dressing) familiar to the person skilled in the art such as dispersions, preferably water-based dispersions, especially preferably “fluid seed treatment” (FS) formulations.

These individual types of formulations are known in principle.

A further object of the present invention is the use of fluquinconazole for the seed treatment of oilseed rape, whereby fluquinconazole is used in combination with further suitable agrochemical active substances.

Further suitable agrochemical active substances which can be used in combination with fluquinconazole are, for example, other fungicides, insecticides, acaricides and/or nematicides, preferably fungicides and insecticides, especially preferably imidazole fungicides such as prochloraz, especially the combination prochloraz/Cu. The ratio (parts by weight) of these further individual agrochemical active substances to fluquinconazole is generally 1:100 to 100:1, preferably 1:10 to 10:1.

Methods commonly used in practice, also known as dressing methods, are used for the seed treatment of oilseed rape with fluquinconazole and/or combinations thereof. Preferably this may involve:
dry-seed dressing (preferably with the addition of adhesion promoting agents such as, for example, paraffin oil or talc) and, if necessary, dyes,
sludge dressing (preferably with the addition of wetting agents, dispersing agents, emulsifiers, adhesives, inert fillers and dyes),
aqueous liquid dressing (preferably with the addition of emulsifiers, dispersing agents, thickening agents, antifreeze agents, polymers, adhesives and dyes),
solvent-containing liquid dressing (with the addition of solvents and dyes),
emulsion dressing (with the addition of emulsifiers, solvents and dyes).

The seed treatment according to the invention is generally carried out in conventional dressing equipment or drum mixers, as are common in the building industry, for example.

A further object of the present invention is a method for combating fungi in oilseed rape, wherein oilseed rape seed is treated with fluquinconazole, whereby fluquinconazole can be combined with suitable additives and/or is used in combination with further suitable agrochemical active substances.

The treatment of oilseed rape seed with fluquinconazole is especially well-suited for combating fungal diseases, caused by phytopathogenic fungi, for example, from the groups Ascomycetes, Deuteromycetes, Basidiomycetes and Hyphomycetes, preferably for combating fungal diseases which damage plants of the genus Brassica, such as for example, Alternaria spp., such as Alternaria alternata f.sp. lycopersici, Alternaria brassicae, Alternaria brassicicola, Alternaria japonica, Alternaria tenussima; Aspergillus spp., such as Aspergillus flavus; Erysiphe spp., such as Erysiphe cruciferarum; Gibberella spp., such as Gibberella avenacea, Gibberella pulicaris; Leptosphaeria spp., such as Leptosphaeria maculans; Phoma spp., such as Phoma lingam; Leveillula spp., such as Leveillula taurica; Sclerotinia spp., such as Sclerotinia sclerotiorum; Thanatephorus spp., such as Thanatephorus cucumeris; Verticillium spp., such as Verticillium dahliae.

A further positive effect of the treatment of oilseed rape seed with fluquinconazole is the increased vitality of the treated plants which is expressed among other things in stronger root growth, and an increase in the formation of plant biomass. An increase in the yield of oilseed rape is thereby possible.

A further object of the present invention is thus a method for increasing the yield of oilseed rape whereby oilseed rape seed is treated with fluquinconazole.

The term oilseed rape, according to the invention, denotes all plants of the type Brassica napus (synonymous with winter rape, summer rape, rape, oilseed rape, canola) and the relevant subspecies, varieties, forms and species obtained in a cultivating and genetic fashion.

The present intention is explained by means of the following examples, without the invention being restricted to these examples.

### A. PRODUCTION EXAMPLES

### Example A1

450 ml of a water-based FS-type formulation containing 167 g/l fluquinconazole (JOCKEY® FLEXI, Aventis CropScience Deutschland GmbH, Germany) was mixed undiluted with 100 kg of purified seed of Brassica napus L. (partim), winter rape, species Express (grower: Norddeutsche Pflanzenzucht, Lembke KG, Hohenlieth, Holtsee, Germany) (concentration of the active substance fluquinconazole: 75.g active substance/100 kg seed).

### Example A2

900 ml of a water-based FS-type formulation containing 167 g/l of fluquinconazole (JOCKEY® FLEXI, Aventis CropScience Deutschland GmbH, Germany) was mixed undiluted with 100 kg of purified seed of Brassica napus L. (partim), winter rape, species Express (grower: Norddeutsche Pflanzenzucht, Lembke KG, Hohenlieth, Holtsee, Germany) (concentration of the active substance fluquinconazole: 150 g of active substance/100 kg of seed).

### Example A3

450 ml of a water-based FS-type formulation containing 167 g/l of fluquinconazole and 34 g/l of prochloraz Cu (JOCKEY®, Aventis CropScience Deutschland GmbH, Germany), was mixed undiluted with 100 kg of purified seed of Brassica napus L. (partim), winter rape, species Bristol (grower: Deutsche Saatveredelung, Lippstadt-Bremen GmbH, Lippstadt, Germany) (concentration of the active substance fluquinconazole: 75 g of active substance/100 kg of seed; concentration of the active substance prochloraz Cu: 15.3 9 of active substance/100 kg of seed).

### Example A4

900 ml of a water-based FS-type formulation containing 167 g/l of fluquinconazole and 34 g/l of prochloraz Cu (JOCKEY®, Aventis CropScience Deutschland GmbH, Germany), was mixed undiluted with 100 kg of purified seed of Brassica napus L. (partim), winter rape, species Bristol (grower: Deutsche Saatveredelung, Lippstadt-Bremen GmbH, Lippstadt, Germany) (concentration of the active substance fluquinconazole: 150 g of active substance/100 kg of seed; concentration of the active substance prochloraz Cu: 30.6 g of active substance/100 kg of seed).

### B. BIOLOGICAL EXAMPLES

### Testing for Examples 1 and 2

The seed treated in accordance with the production examples described above was tested in field trials at a sowing rate of 4 kg per hectare. The individual test parameters were evaluated using the methods usually used in practice in each case, such as determining the weight for plant biomass and grading in the event of fungal infestation.

### Example B1

| Brassica napus | | |
|---|---|---|
| (winter rape, species Express) | Yield (site 1) | Yield (site 2) |
| JOCKEY ® FLEXI | | |
| 450 ml/100 kg seed¹ | 104% | 103% |
| 900 ml/100 kg seed² | 103% | 101% |
| Untreated | 100% (=42.4 dt)³⁾ | 100% (=44.5 dt)³⁾ |

¹Concentration of the active substance fluquinconazole: 75 g of active substance/100 kg of seed
²Concentration of the active substance fluquinconazole: 150 g of active substance/100 kg of seed
³dt = ‘decitonne’ = 100 kg

The yield after a period of vegetation is higher after treatment of the oilseed rape seed with fluquinconazole compared with the untreated control. This effect is independent of the site.

### Example B2

| | 24 days after sowing | | | |
|---|---|---|---|---|
| | | Foliar | 41 days after sowing | |
| | Plant | infestation | | Fungal |
| | biomass | with downy | Plant | infestation |
| Brassica napus | (% - | mildew | biomass | of the leaves |
| (winter rape, | relative to | (% total | (% - relative | (% total |
| species Bristol) | untreated) | infestation) | to untreated) | infestation) |

Embodiment 1: JOCKEY ® FLEXI

| | | | | |
|---|---|---|---|---|
| 450 ml/100 kg | 105 | 5 | 115 | 5 |
| seed¹ | | | | |
| 900 ml/100 kg | 105 | 7 | 115 | 5 |
| seed² | | | | |

Embodiment 2: JOCKEY ®

| | | | | |
|---|---|---|---|---|
| 450 ml/100 kg | 103 | 5 | 112 | 7 |
| seed³ | | | | |
| 900 ml/100 kg | 105 | 5 | 110 | 7 |
| seed⁴ | | | | |
| Dimethomorph⁵ | 105 | 5 | 102 | 25 |
| Untreated | 100 | 15 | 100 | 30 |

¹Concentration of the active substance fluquinconazole: 75 g of active substance/100 kg seed
²Concentration of the active substance fluquinconazole: 150 g of active substance/100 kg seed
³Concentration of the active substances/100 kg of seed: fluquinconazole 75 g of active substance, prochloraz Cu 15.3 g of active substance
⁴Concentration of the active substances/100 kg of seed: fluquinconazole 150 g of active substance, prochloraz Cu 30.6 g of active substance
⁵Standard treatment agent co-tested as reference

The increase in the plant biomass and the suppression of fungal infestation in both the exemplary embodiments of treatment of oilseed rape seed with fluquinconazole is higher compared with the untreated control and compared with the active substance dimethomorph which was co-tested as a reference and is used as the standard treatment agent in oilseed rape for protection against downy mildew.

1. The use of fluquinconazole for the seed treatment of oilseed rape.

2. The use according to claim 1, wherein fluquinconazole is combined with suitable additives.

3. The use according to claim 1 or 2, wherein fluquinconazole is used in combination with the active substance Prochloraz.

4. The use according to claim 1, wherein fluquinconazole is used in concentrations of 0.001 to 50 g of active substance per kilogram of seed.

5. A method for combating fungi in oilseed rape wherein oilseed rape seed is treated with fluquinconazole.

6. The method according to claim 5, wherein fluquinconazole is combined with suitable additives.

7. The method according to claim 5 or 6, wherein fluquinconazole is used in combination with the active substance prochloraz.

8. The method according to claim 5, wherein fluquinconazole is used in concentrations of 0.001 to 50 g of active substance per kilogram of seed.

9. A method for increasing the yield of oilseed rape wherein oilseed rape seed is treated with fluquinconazole.
